(19) United States
(12) Patent Application Publication
(10) Pub. No.: US 2007/0006409 A1
(43) Pub. Date: Jan. 11, 2007

(54) One step copper pipe fitting abrasion preparation

(76) Inventor: Steven Joseph Vargas, Santa Fe, NM (US)

Correspondence Address: Walter A. Michel, 548 Vista De La Ciudad, Santa Fe, NM, 87501, US

(21) Appl. No.: 11/174,635

(22) Filed: Jul. 6, 2005

(51) Int. Cl. B08B 9/023

(52) U.S. Cl. 15/104.04; 15/104.095

(57) ABSTRACT

A tool for abrading or polishing and reaming the terminal ends of tubing or fittings using a hand-held electrically powered device having a rotating member capable of accepting a standard shaft which has attached to it a male and female abrasive member which will polish or abrade the inside and outside of a length tubing or fitting respectively using the same tool. Also attached to the standard shaft is a reamer for removing unwanted material from the end of the length of tubing. All of these members are attached at the same end of the standard shaft, thereby allowing all the operations to be performed at one time on each tubing or mating fitting member. In addition, the standard shaft may be connected to a clutch release mechanism allowing the tool mechanism to disengage upon the application of excessive torque.

### FIELD OF THE INVENTION

This invention relates to portable electrically powered rotating devices for cleaning and/or polishing the inside and outside of metal pipes in preparation for soldering. This invention also includes a tool for reaming the ends of pipes thereby removing any burrs, which are the result of cutting. Finally, this invention performs all these functions in one operation and is capable of accommodating many sizes of pipes.

### BACKGROUND ART

It is extremely important that copper pipes and copper fittings be free from any foreign matter, dirt, etc. prior to fitting two pipes together in a secure and waterproof joint. This is normally accomplished by abrading or polishing the inside of the pipe or pipe fitting and then performing the same abrasion or polishing of the outside of the pipe or pipe fitting in two separate operations. Finally, it is necessary to remove the burrs left from the cutting of the copper pipe in yet another operation. Many attempts have been made at accomplishing these functions in various configurations of tools. However, none have been able to accomplish all these operations in one simple step until now. The patents described below (which appear in chronological order) illustrate various attempts at cleaning pipes, however, only one comes even close to combining these operations. That is U.S. Pat. No. 5,307,534 by Miller and issued on May 3, 1994.

For example U.S. Pat. No. 4,575,892 discloses a multiple of brushes called abrasion members for cleaning a multiple of male and female electrical conductors such as used in a car to trailer electrical connection. Male and female cleaning brushes being at opposite ends of the main tool body.

U.S. Pat. No. 4,600,444 discloses a permanently mounted (not portable) device for cleaning pipe and tubing whereby the pipes or tubing are of substantially equal length and can be cleaned at both ends simultaneously, both inside and outside, and the distance between the opposite ends can vary between 18″ and 24″ from end of pipe.

U.S. Pat. No. 4,862,549 discloses only a hard bristle brush for abrading the inside and the outside of a pipe at the same time from the same end of a tool. The brush for cleaning the inside extends forward of the other brush and the bristles are of hard drawn carbon steel wires. The inner brush being attached to the shell by various means such as brazing or adhesive bonding, etc. while the outer shell can be of various materials.

U.S. Pat. No. 5,038,525 discloses a fixture to be mounted on an electric drill. Said fixture incorporates a mechanism that holds the pipe captive while the cleaning and reaming operation take place. This mechanism only allows cleaning of the outside of the pipe with an abrasive continuous pad and a mounted reamer.

U.S. Pat. No. 5,099,537 discloses a combination cleaner and reamer for cleaning tubes and fittings which includes a base plate housing for accommodating multiple brushes for both internal and external cleaning and is designed to be mounted on and powered by an electric drill.

U.S. Pat. No. 5,157,802 discloses a stationary device, not portable, for cleaning pipes with brushes and high-powered cleaning fluid from jets. This patent is aimed toward cleaning pipes at petroleum related cites.

U.S. Pat. No. 5,307,534 discloses a handheld tool with bristle brushes at either end and including a reamer at the end with the brush for cleaning the outside of the pipe.

U.S. Pat. No. 5,493,748 discloses brushes, which are to be used in conjunction with an electric drill. This disclosure only allows for the use of one brush at a time, either for cleaning the interior or cleaning the exterior of a pipe.

U.S. Pat. No. 6,065,173 discloses a bench mounted device with two separate motors. One for cleaning the interior and the other for the exterior of a pipe. Automatic turn on when the pipe is inserted over the brush assembly or inside the brush assembly.

U.S. Pat. No. 6,106,370 discloses a fixed device, rather than portable for cleaning the outside of a pipe with abrasive pads rather than bristle brushes and includes a reamer at the end of the pipe. Also includes a method for performing these tasks.

U.S. Pat. No. 6,393,645 discloses only the twisted steel brush assembly to be used with a power drill. The brush for cleaning the inside is retractable within the assembly and the brush for cleaning the outside can then be used. Thereby allowing only one operation at a time.

### BRIEF SUMMARY OF THE INVENTION

It is an object of this invention to provide a tool that is used in the preparation of cleaning copper pipe and its connecting fittings for soldering the pieces together. The cleaning of both the inside of the copper fitting and the inside and outside of a copper pipe as well as de-burring the end of the copper pipe can all be done at one time, thereby reducing the time required and increasing the efficiency of the operation.

### BRIEF DESCRIPTION OF THE SEVERAL VIEWS OF THE DRAWINGS

FIG. 1. is an overall view of the tube polishing or abrading apparatus showing attachment to a rotating mechanism.

FIG. 2. is a front view of the tube polishing or abrading apparatus.

FIG. 3. is a side view of the tube polishing or abrading apparatus.

FIG. 4. is a side view of the tube polishing or abrading apparatus showing engagement with a length of tubing.

FIG. 5. is a side view of the tube polishing or abrading apparatus illustrating the addition of a torque control clutch.

FIG. 6. is a side view of the tube polishing or abrading apparatus showing the engagement of a copper fitting that mates with the tubing shown in FIG. 4.

### DETAILED DESCRIPTION OF THE INVENTION

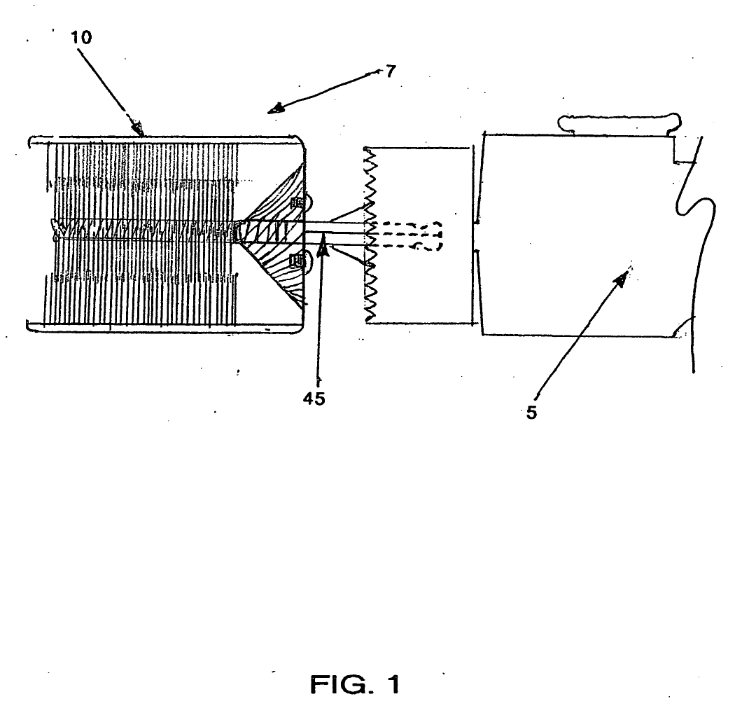

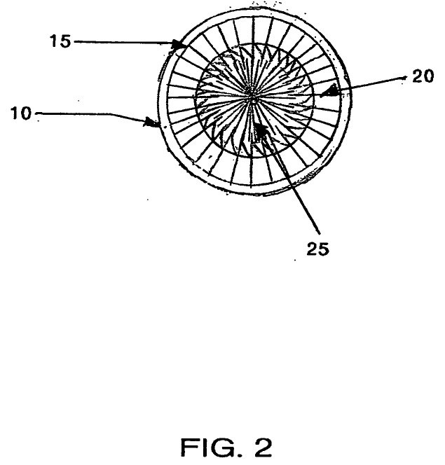

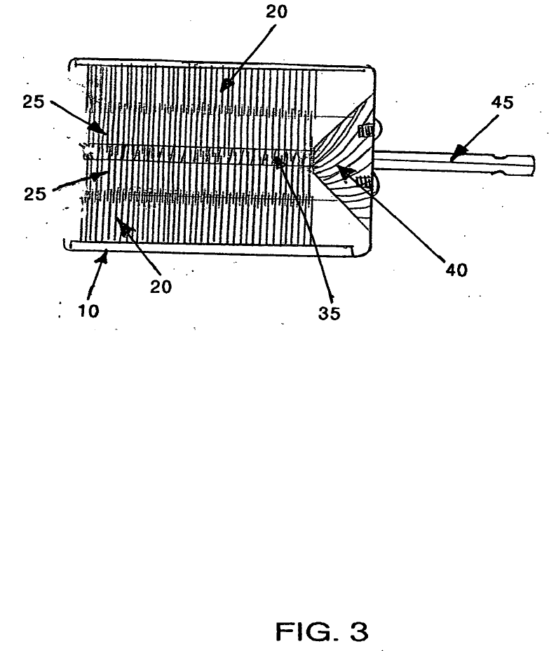

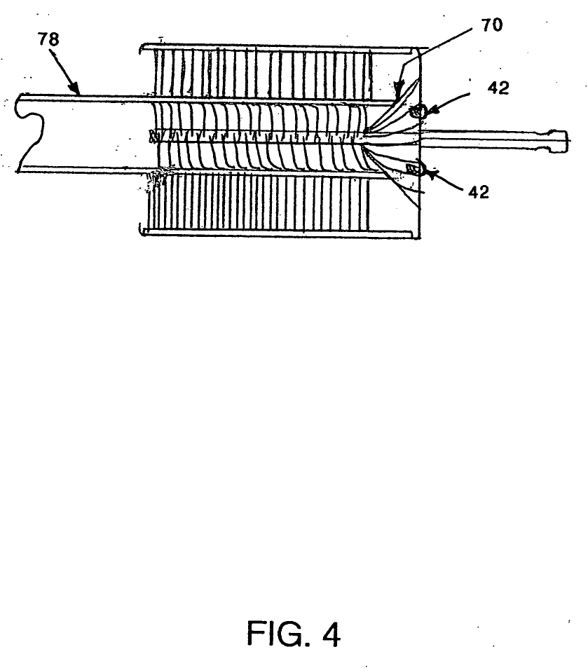

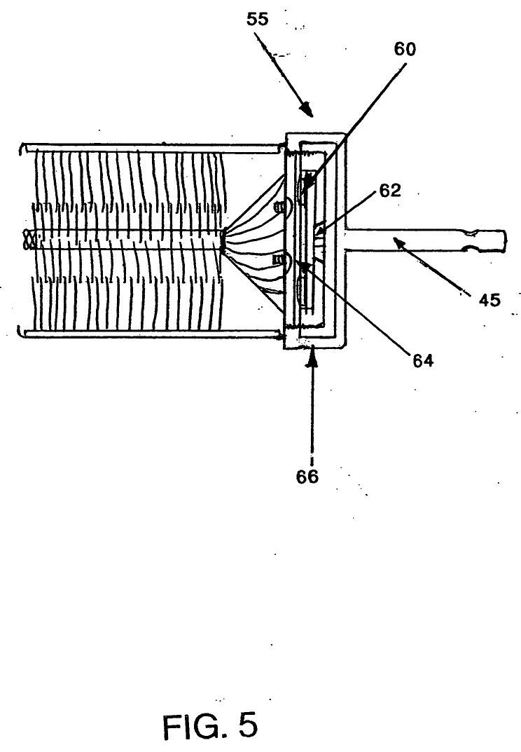

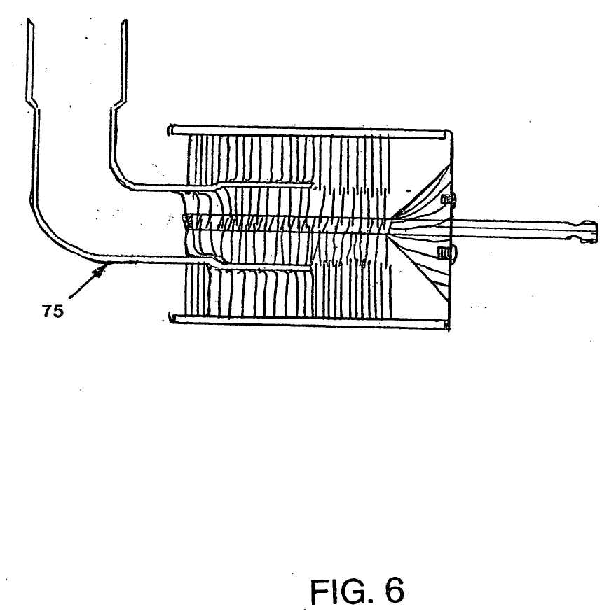

As shown in FIG. 1, the rotating mechanism (5) is attached to the tool (7) which is made up of an aluminum housing (10) and a connecting shaft (45). The front view of FIG. 2 shows the housing (10) which contains a first mass of inwardly facing wire bristles attached on the inner-side of the housing to a bristle binder (15) and referred to as the female abrading member (20). A second mass of outwardly facing wire bristles, referred to as the male abrading member (25) are shown inwardly of the female abrading member (20). In FIG. 3 it can be seen that the male abrading member (25) is connected to a hexagonal shaft (35) that is centered in the housing (10) overlapping the female abrading member (20) by approximately 1/16″. One end of the hexagonal shaft (35) is centrally attached to an octagon shaft (45) which will mate with a rotating mechanism (5) or a standard cordless drill as shown in FIG. 1. At the end of the hexagonal shaft (35) which mates with octagon shaft (45) is a reamer (40), mounted by means of set screws (42) or any other convenient means, that will remove the burrs from the end (70) of the copper tubing (78) with a slight inwardly push of said tubing (78), as shown in FIG. 4. This unit will work for both the fittings and the pipe that are of the same size. The one step tool includes sizes that will accommodate diameters from ⅜″ upward of copper tubing. The main difference of this tool from others in the field is a singly housed unit (7) that performs three operations at one time. The combination of flexible bristles that overlap each other is what allows the preparation of a copper pipe (78) to a mating copper fitting (75) for soldering as shown in FIGS. 4 and 6 respectively and which are by necessity of slightly different diameters in order to fit within one another and the same tool prepares the inside diameter surface and the outside diameter surface of the copper tubing in one operation. The unit is versatile with most ⅜″ hand driven cordless drills but can also include the added feature of a clutch driven driver (55) as shown in FIG. 5 which is made up of a hand twist clutch adjustment (66), a flywheel with bearing grooves (64), a pressure plate (62) and bearings (60).

Although the invention has been described by reference to some embodiments, it is not intended that the novel apparatus for abrading or polishing and reaming the terminal ends of tubing be limited thereby, but that modifications thereof are intended to be included as falling within the broad spirit and scope of the foregoing disclosure, the following claims and the appended drawings.

What is claimed is:

1. A tool for abrading or polishing and reaming the terminal ends of tubing and fittings comprising a hand-held electrically powered device having a rotating extension capable of accepting a shaft which is connected concentrically to a male abrasive member adapted for insertion into and rotatably and abrasively engaging the inner surface of the end of a length of tubing or fitting and a female abrasive member attached to an outer circumferential housing which encompasses the entire tool and is also attached to said shaft at an end opposite the entry point of the length of tubing or fitting and adapted for enveloping and rotatably and abrasively engaging the outer surface of the end of a length of tubing or fitting and a reaming device for removing unwanted material from the end of a length of tubing in order for the tubing to be abraded and reamed to permit subsequent joining of the tubing to a like abraded fitting to form a continuous length of tubing.

2. The tool of claim 1 wherein said female abrasive members, said male abrasive members and said reaming device are rotatably and concentrically connected to each other at an end opposite the entry point of the length of tubing or fitting, thereby performing the functions previously described during one insertion of the length of tubing or fitting into said tool.

3. The tool of claim 1 wherein the female abrasive members are wire bristled brushes attached to the aforesaid outer housing by various bonding means.

4. The tool of claim 1 wherein the male abrasive members are wire bristled brushes attached to the aforesaid shaft by various bonding means.

5. The tool of claim 3 wherein the female wire bristled brushes are flexible enough to accommodate the difference in the outside diameter of a length of tubing and the outside diameter of a mating fitting.

6. The tool of claim 4. wherein the male wire bristled brushes are flexible enough to accommodate the difference in the inside diameter of a length of tubing and the inside diameter of a mating fitting.

7. A tool for abrading or polishing and reaming the terminal ends of tubing and fittings comprising a hand-held electrically powered device having a rotating extension capable of accepting a first shaft which is concentrically attached to a second shaft which is in turn connected concentrically to a male abrasive member adapted for insertion into and rotatably and abrasively engaging the inner surface of the end of a length of tubing or fitting and a female abrasive member attached to an outer circumferential housing which encompasses the entire tool and is also attached to the concentric second shaft at an end opposite the entry point of the length of tubing or fitting and adapted for enveloping and rotatably and abrasively engaging the outer surface of the end of a length of tubing or fitting and a reaming device for removing unwanted material from the end of a length of tubing in order for the tubing to be abraded and reamed to permit subsequent joining of the tubing to a like abraded fitting to form a continuous length of tubing.

8. The tool of claim 7 wherein said female abrasive members, said male abrasive members and said reaming device are rotatably and concentrically connected to each other at an end opposite the entry point of the length of tubing or fitting, thereby performing the functions previously described during one insertion of the length of tubing or fitting into said tool.

9. The tool of claim 7 wherein the female abrasive members are wire bristled brushes attached to the aforesaid outer housing by various bonding means.

10. The tool of claim 7 wherein the male abrasive members are wire bristled brushes attached to the aforesaid second shaft by various bonding means.

11. The tool of claim 9 wherein the female wire bristled brushes are flexible enough to accommodate the difference in the outside diameter of a length of tubing and the outside diameter of a mating fitting.

12. The tool of claim 10. wherein the male wire bristled brushes are flexible enough to accommodate the difference in the inside diameter of a length of tubing and the inside diameter of a mating fitting.

13. A tool for abrading or polishing and reaming the terminal ends of tubing and fittings comprising a hand-held electrically powered device having a rotating extension capable of accepting a first shaft which is concentrically attached to a second shaft which is in turn connected concentrically to a clutch release mechanism allowing the tool mechanism to disengage upon the application of excessive torque and the said second shaft is concentrically connected to a male abrasive member adapted for insertion into and rotatably and abrasively engaging the inner surface of the end of a length of tubing or fitting and a female abrasive member attached to an outer circumferential housing which encompasses the entire tool and is also attached to the said second shaft at an end opposite the entry point of the length of tubing or fitting and adapted for enveloping and rotatably and abrasively engaging the outer surface of the end of a length of tubing or fitting and a reaming device for removing unwanted material from the end of a length of tubing in order for the tubing to be abraded and reamed to permit subsequent joining of the tubing to a like abraded fitting to form a continuous length of tubing.

14. The tool of claim 13 wherein said female abrasive members, said male abrasive members and said reaming device are rotatably and concentrically connected to each other at an end opposite the entry point of the length of tubing or fitting, thereby performing the functions previously described during one insertion of the length of tubing or fitting into said tool.

15. The tool of claim 13 wherein the female abrasive members are wire bristled brushes attached to the aforesaid outer housing by various bonding means.

16. The tool of claim 13 wherein the male abrasive members are wire bristled brushes attached to the aforesaid second shaft by various bonding means.

17. The tool of claim 15 wherein the female wire bristled brushes are flexible enough to accommodate the difference in the outside diameter of a length of tubing and the outside diameter of a mating fitting.

18. The tool of claim 16 wherein the male wire bristled brushes are flexible enough to accommodate the difference in the inside diameter of a length of tubing and the inside diameter of a mating fitting.
